(19) United States
(12) Patent Application Publication
(10) Pub. No.: US 2007/0065131 A1
(43) Pub. Date: Mar. 22, 2007

(54) Auto-focusing and Zooming Systems and Method of Operating Same

(76) Inventors: Chengping Wei, Gilbert, AZ (US); Jun Shen, Phoenix, AZ (US)

Correspondence Address: JUN SHEN, 1956 E. DESERT WILLOW DR., PHOENIX, AZ, 85048, US

(21) Appl. No.: 11/532,905

(22) Filed: Sep. 19, 2006

Related U.S. Application Data
(60) Provisional application No. 60/596,372, filed on Sep. 20, 2005.

(51) Int. Cl. G03B 13/18; G03B 3/00; G03B 13/32

(52) U.S. Cl. 396/89

(57) ABSTRACT

Auto-focusing systems are formed by mounting a lens on a flexible membrane on top of an image sensor. A permanent magnet provides a dominantly perpendicular first magnetic field near the center of the membrane. A coil is also formed on the membrane so that a second magnetic field is produced when current flows in the coil. The interaction between the first and second magnetic field creates an attractive or repulsive force between the permanent magnet and the coil, causing the membrane and the lens to move. The position of the lens is adjusted by the coil current for the focusing operation. An alternative embodiment utilizes attraction between two magnetic poles induced by coil current to adjust lens positions. Zooming capability is realized by stacking multiple lens assemblies on top of each other.

### CROSS REFERENCE TO RELATED APPLICATIONS

This patent application claims the benefit of U.S. Provisional Patent Application Ser. No. 60/596,372, filed on Sep. 20, 2005, which is hereby incorporated by reference.

### FIELD OF THE INVENTION

The present invention relates to auto-focusing and zooming systems. More specifically, the present invention relates to auto-focusing and zooming systems using electromagnetic actuation for optical imaging applications and to methods of operating and formulating auto-focusing and zooming systems.

### BACKGROUND OF THE INVENTION

Auto-focusing and zooming systems are widely used in optical imaging devices and other mechanical systems, such as cameras, and video recorders. Traditionally, small motors are utilized to move lenses in an optical assembly for auto-focusing and zooming purposes. Optical and electrical circuits are connected to the optical imager and the motors to form a closed loop feedback system for auto-focusing and zooming.

A micro-miniature auto-focusing and zooming system is described in U.S. Pat. No. 6,914,635 B2 issued to Ostergard on Jul. 5, 2005, the entirety of which is incorporated herein by reference [1]. In this system, the image sensor is formed on a substrate and is mounted on a micro-electromechanical system for movement relative to the camera lens to provide an auto-focus capability. In addition the lens may be mounted on a micro-electromechanical system for movement relative to the image sensor to provide both the auto-focusing and zooming capability. Electrostatic resonators are utilized the mechanical actuation purposes.

Another micro actuator system for focusing in a charge-coupled device (CCD) camera is described in an article by Koga et al. [2]. Electrostatic linear micro-actuators with large movement range was developed and used to focusing the lens to a CCD imager.

Typically, high voltages are needed for actuation in an electrostatic actuator. Complicated charge pumping and driving schemes are needed for the high voltage actuation.

Also the sizes of the existing actuators used in auto-focusing systems are relatively large, especially along the lens thickness. In order to fabricate a miniature auto-focusing lens for mobile devices such as a cellular phone camera, it usually requires very sophisticated mechanical systems to accommodate the large size of the actuator to fit in the lens assembly. Auto-zooming is another major challenge for exiting actuation devices. The requirement of moving a series of lenses individually for zooming function in an imaging system complicates the driving scheme. To fit the auto zoom device in a very small lens assembly is even more difficult. Therefore, the actuator is a key limiting factor for making a low cost, highly manufacture-able micro auto-focusing and zooming system.

Accordingly, it would be highly desirable to provide a compact and efficient auto-focusing and zooming system which requires low driving voltage and is also simple and easy to manufacture and use.

It is a purpose of the present invention to provide a new and improved auto-focusing and zooming system.

It is another purpose of the present invention to provide a new and improved auto-focusing and zooming system in optical imaging devices and other mechanical systems that require linear movement which is easy to drive and simple and easy to manufacture.

### SUMMARY OF THE INVENTION

The above problems and others are at least partially solved and the above purposes and others are realized in a magnetically actuated auto-focusing and zooming system as to be described in detail below. Briefly, the auto-focusing systems are formed by mounting a lens on a flexible membrane on top of an image sensor. A permanent magnet provides a dominantly perpendicular first magnetic field near the center of the membrane. A coil is also formed on the membrane so that a second magnetic field is produced when current flows in the coil. The interaction between the first and second magnetic field creates an attractive or repulsive force between the permanent magnet and the coil, causing the membrane and the lens to move. The position of the lens is adjusted by the coil current for the focusing operation. An alternative embodiment utilizes attraction between two magnetic poles induced by coil current to adjust lens positions. Zooming capability is realized by stacking multiple lens assemblies on top of each other.

### BRIEF DESCRIPTION OF THE FIGURES

The above and other features and advantages of the present invention are hereinafter described in the following detailed description of illustrative embodiments to be read in conjunction with the accompanying figures, wherein like reference numerals are used to identify the same or similar parts in the similar views, and:

FIG. 1 is a front view of an exemplary embodiment of an auto-focusing system;

FIG. 2 is a 3-dimensional breakout view of the auto-focusing system shown in FIG. 1;

FIG. 3 is the 3-dimension view of the assembled auto-focusing system shown in FIG. 1;

FIG. 4 is a front view of an exemplary embodiment of an auto-focusing and zooming system;

FIG. 5 is a 3-dimensional breakout view of the auto-focusing and zooming system shown in FIG. 4;

FIG. 6 is the 3-dimension view of the assembled auto-focusing and zooming system shown in FIG. 5;

FIG. 7 is a front view of an exemplary alternative embodiment of an auto-focusing system;

FIG. 8 is a front view of an exemplary alternative embodiment of an auto-focusing and zooming system.

### DETAILED DESCRIPTION OF EXEMPLARY EMBODIMENTS

It should be appreciated that the particular implementations shown and described herein are examples of the invention and are not intended to otherwise limit the scope of the present invention in any way. Indeed, for the sake of brevity, conventional electronics, manufacturing, and other functional aspects of the systems (and components of the individual operating components of the systems) may not be described in detail herein. Furthermore, for purposes of brevity, the invention is frequently described herein as pertaining to an auto-focusing and zooming system for use in optical imaging applications. It should be appreciated that many other manufacturing techniques could be used to create the auto-focusing and zooming system described herein, and that the techniques described herein could be used in optical imaging systems, fluidic control systems, optical and electrical switching systems, or any other tuning or adjusting systems. Further, the techniques would be suitable for application in optical systems, electrical systems, consumer electronics, industrial electronics, wireless systems, space applications, fluidic control systems, medical systems, or any other application. Moreover, it should be understood that the spatial descriptions made herein are for purposes of illustration only, and that practical auto-focusing and zooming systems may be spatially arranged in any orientation or manner. Arrays of these systems can also be formed by connecting them in appropriate ways and with appropriate devices.

Auto-Focusing System

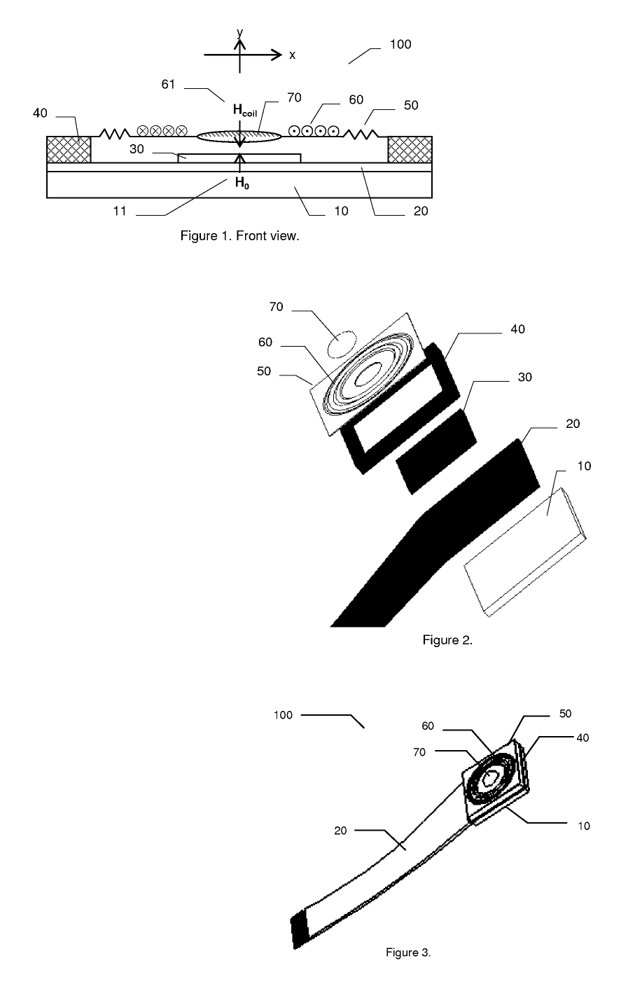

FIGS. 1-3 show an auto-focusing system. With reference to FIGS. 1-3, an exemplary auto-focusing system 100 suitably includes a permanent magnet 10, a circuit layer 20, an image sensor 30, spacer layers 40, a flexible membrane 50, a coil 60, and a lens 70.

Permanent magnet 10 is preferably magnetized permanently through thickness (along y-axis). In an exemplary embodiment, magnetic layer 10 is a thin SmCo permanent magnet with an approximate remnant magnetization (Bᵣ=μ₀M) of about 1 T through thickness (predominantly along y-axis). Other possible hard magnetic materials are, for example, NdFeB, AlNiCo, Ceramic magnets (made of Barium and Strontium Ferrite), CoPtP alloy, and others, that can maintain a remnant magnetization (Bᵣ=μ₀M) from about 0.001 T (10 Gauss) to above 1 T (10⁴ Gauss), with coercivity (H_{c}) from about 7.96×10² A/m (10 Oe) to above 7.96×10⁵ A/m (10⁴ Oe). Magnet 10 produces a first magnetic field 11 (H₀ indicated by an arrow) which is dominantly perpendicular at the center region. In the example shown in FIG. 1, a first magnetic field 11 points upward near the center.

Circuit layer 20 includes conducting metal traces for access to the various components in the system (image sensors, coil, etc.). Circuit layer 20 can be made of dielectric material such as polyimide, FR4, and so on.

Image sensor 30 is a solid state digital sensor (for example, a CMOS image sensor or a charge-coupled device (CCD). The purpose of sensor 30 is to convert optical images received into electronic signals and then send them to subsequent signal and data processing unit for processing and storage. For optimal effect, the optical image of a target object at image sensor 30 should be focused. On the other hand, image sensor 30 in auto-focusing system 100 can be replaced by conventional optically sensitive photographic films as used in conventional cameras.

Spacers 40 can be any preformed material that can provide a support to membrane 50 and form a cavity between the lens 60 and image sensor 30 so that lens 60 can move freely relative to image sensor 30.

Membrane 50 is a flexible layer that supports lens 70 at the center and hinges onto spacer 40 on the side. Membrane 50 can be any flexible material (dielectric material such as polyimide, or metallic material such as beryllium copper, permalloy, or others). A hole is formed at the center of membrane 50 to allow an optical lens 70 to be mounted there. Flexible springs are formed (by pressing, stamping, etching, or other means) in the membrane so that lens 70 mounted at the center of the membrane can move up or down during focusing.

Coil 60 is formed by winding electrically conducting metal traces on membrane 50. The metal traces can be any electrically conducting material such as copper, aluminum, gold, etc. The metal traces can be formed by deposition and photo-lithographically patterning and etching means, or others. If necessary, an insulating layer can be deposited below the coil to prevent shorting of the traces. Electrical connections are suitably formed at the two ends of the coil windings. When current passes the coil traces, it produces a second magnetic field 61 (H_{coil}) which is also predominately perpendicular near the center of coil 60. The direction (pointing up or down) of second magnetic field 61 depends on the direction of the current in the coil traces.

Lens 70 can be made of transparent materials such as glass, plastics or others. Special shapes (convex, concave, or others) can be preformed on lens 70 for various focusing needs. Lens 70 is mounted (glued, adhered) onto the hole at the center of membrane 50.

Other additional layers, such as dust covers, magnetic shielding layers, etc., can be added for various purposes, but are omitted here for the purpose of brevity.

Principle of Auto-Focusing Operation

In a broad aspect of the invention and with reference to FIG. 1, magnet 10 produces a first magnetic field 11 near the center of auto-focusing system 100. When current passes coil 60, it produces a second magnetic field 61 which interacts with first magnetic field 11. When the direction of second magnetic field 61 aligns with the direction of first magnetic field 11 near the center of coil 10, lens 70 is attracted toward magnet 10 and stabilizes to a position when the attractive force is balanced out by the spring restoring force in membrane 50. On the other hand, when the field directions are opposite, lens 10 is pushed upward by a repulsive force. The amount of movement of lens 10 is proportional to the magnitude of the current flown in coil 10. Apparently, by adjusting the direction and magnitude of the current in coil 10, one can adjust the position of lens 70 relative to image sensor 30, achieving the optical focusing objectives.

Electronic feedback circuits (not shown) are connected to coil 60 and image sensor 30 so that the coil current and thus the position of lens 70 can be tuned automatically until a sharpest image is formed at image sensor 30.

Auto-Focusing and Zooming System

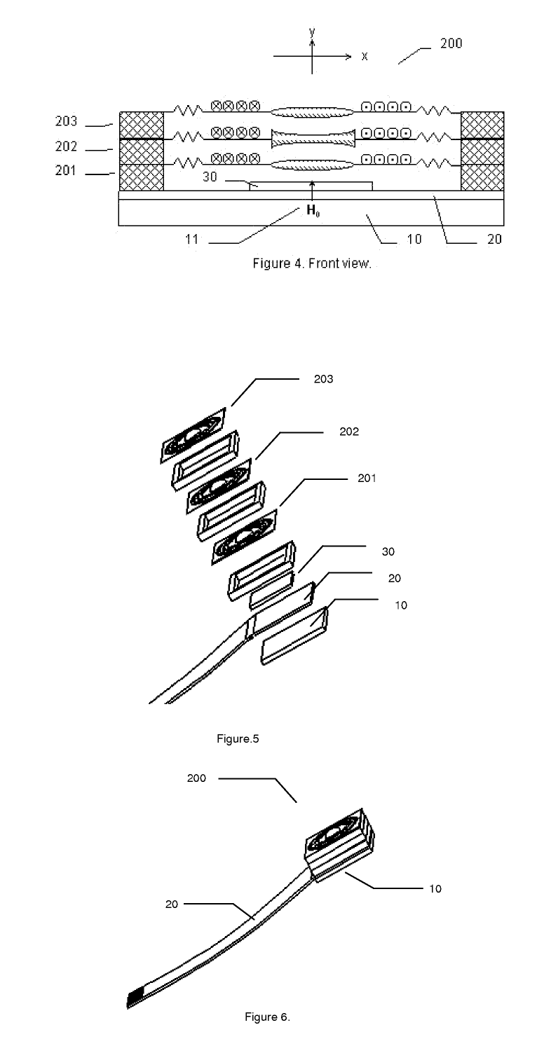

FIGS. 4-6 disclose an exemplary embodiment of an auto-focusing system with zooming capabilities.

With reference to FIGS. 4-6, an exemplary auto-focusing and zooming system 200 suitably includes a permanent magnet 10, a circuit layer 20, an image sensor 30, and lens assemblies 201, 202, and 203. Each lens assembly stack is similarly constructed by forming coil 60 and lens 70 on a flexible membrane 50 as shown in FIG. 1. The lens stacks are separated from each other by multiple layers of spacer 40.

Other additional layers, such as dust covers, magnetic shielding layers, etc., can be added for various purposes, but are omitted here for the purpose of brevity.

Principle of Zooming Operation

With reference to FIGS. 4-6, magnet 10 produces a first magnetic field 11 near the center of auto-focusing system 200. Second, third, and fourth magnetic fields can be produced by passing individual electrical current through each coil in coil assemblies 201, 202, and 203, respectively. The interactions between the magnetic fields can cause each lens to move relative to image sensor 30. The amount of lens movement depends on the direction and magnitude of the coil current. Apparently by adjusting the individual coil current, the position of each lens relative to the image sensor 30 can be tuned for auto-focusing and zooming purposes.

Alternative Embodiments of Auto-Focusing and Zooming System

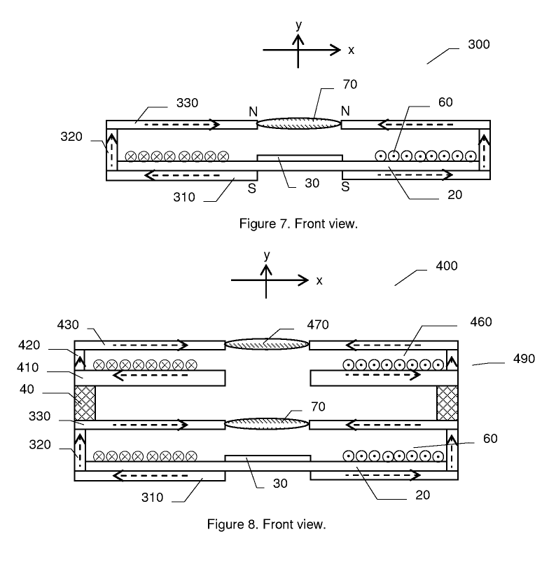

FIG. 7 discloses an alternative exemplary embodiment of the auto-focusing system. In this embodiment (FIG. 7), auto-focusing system 300 comprises magnetically sensitive layers 310, 320, and 330, a circuit substrate 20, an image sensor 30, a coil 60, and a lens 70. Magnetically sensitive layers 310, 320, and 330 can be made of soft magnetic materials such as permalloy (NiFe alloy), Iron, Silicon Steels, FeCo alloys, soft ferrites, etc. Alternatively, layer 320 can be a spacer layer similar to spacer layers 40 as specified in reference to FIG. 1. Magnetic layer 330 is made flexible enough so that the lens mounted at the center can move up or down freely. Other elements can be made of similar materials and of similar functions as elements with the corresponding numerals as described in reference to FIG. 1. When an electrical current passes through coil 60, magnetic layers 310, 320, and 330 become magnetized as indicated by dashed arrowed lines. The arrows indicate the magnetization directions of the magnetic layers. For example, on the left-hand side, the coil current flows into the paper, producing a clockwise magnetization in the magnetic layer around the coil windings. A north pole (N) is formed at the upper end and a south pole (S) is formed at the lower end. Similar poles are formed on the right-hand side. The north poles at the upper magnetic layer 330 are attracted to the south poles at the lower magnetic layer 310, causing magnetic layer 330 to deflect downward and bringing lens 70 downward. The deflection and lens movement stops when the spring restoring force of magnetic layer 330 balances the pole magnetic attraction force. The amount of lens movement is proportional to the magnitude of the coil current. Such a mechanism is the basis of the auto-focusing function of assembly 300. One can adjust the position of lens 70 relative to image sensor 30 by adjusting the magnitude of coil current, achieving the optical focusing objectives. It is worth noting that in this case, the direction of the coil current does not play a significant role because always opposite poles are formed at the two ends (upper or lower) of layer 310 and 330 and only attraction (not repulsion) is produced between the two ends.

Similarly, an auto-focusing and zooming system can be formed by stacking multiple basic lens assemblies (FIG. 7) on top of each other. FIG. 8 shows an exemplary embodiment of such a system. With reference to FIG. 8, an auto-focusing system (FIG. 7) is formed at the bottom of the auto-focusing and zooming system 400. Another similar lens assembly 490 (without the image sensor and circuit layer 20) is stacked on top of layer 330 with spacers 40 in between. Lens assembly 490 has the similar magnetically sensitive layers 410, 420, and 430, coil 460, and lens 470. In this case, the bottom magnetic layer 410 can be made thicker so that it is more rigid and its induced magnetization (by the upper coil) is more focused on the upper side of the layer (minimizing interaction between 410 and 330). Similar to what was discussed in reference to FIG. 7, currents flown in coils 60 and 460 produce magnetization in the magnetically sensitive layers around the coils. The induced magnetic poles attract to each other, causes the magnetic and flexible layers 330 and 430 to deflect and lenses 70 and 470 to move. By adjusting the amount of current flown in the coils, the lens positions can be adjusted to achieve the auto-focusing and zooming operations.

It will be understood that many other embodiments and combinations of different choices of materials and arrangements could be formulated without departing from the scope of the invention. Similarly, various topographies and geometries of the auto-focusing and zooming system could be formulated by varying the layout of the various components.

The corresponding structures, materials, acts and equivalents of all elements in the claims below are intended to include any structure, material or acts for performing the functions in combination with other claimed elements as specifically claimed. Moreover, the steps recited in any method claims may be executed in any order. The scope of the invention should be determined by the appended claims and their legal equivalents, rather than by the examples given above.

### REFERENCE

[1] U.S. Pat. No. 6,914,635 B2.

[2] A. Koga, K. Suzumori, H. Sudo, S. likura, and M. Kimura, “Electrostatic Linear Microactuator Mechanism for Focusing a CCD camera,” Journal of Lightwave Technology, p. 43-47, vol. 17, No. 1, January 1999.

What is claimed is:

1. An auto-focusing system comprising:
an image sensor;
a permanent magnet producing a first magnetic field;
a lens assembly comprising a lens and an electromagnet mounted on a movable membrane wherein energizing said electromagnet generates a second magnetic field which interacts with said first magnetic field and generates a magnetic force on said movable membrane to cause said lens to move toward or away from said image sensor until said magnetic force is balanced by a spring restoring force on said movable membrane;
whereby the relative distance between said lens and said image sensor can be adjusted accordingly by adjusting said second magnetic field.

2. The auto-focusing system of claim 1 wherein said electromagnet comprises a coil.

3. The auto-focusing system of claim 2 wherein said coil is a planar coil with at least one turn of conductor trace.

4. The auto-focusing system of claim 1 wherein said first magnetic field is predominately perpendicular to said membrane.

5. The auto-focusing system of claim 1 wherein electronic image processing and feedback circuits are connected to said electromagnet to adjust said relative distance between said lens and said image sensor by adjusting said second magnetic field.

6. The auto-focusing system of claim 1 wherein multiples of said lens assembly are stacked together wherein the distance between each individual lens and said image sensor can be adjusted by adjusting the magnetic field produced by the corresponding electromagnet whereby a zooming function can be realized.

7. A method of operating an auto-focusing system comprising the steps of:
providing an image sensor;
providing a permanent magnet which produces a first magnetic field;
providing a lens assembly comprising a lens and an electromagnet mounted on a movable membrane;
energizing said electromagnet to generate a second magnetic field which interacts with said first magnetic field and generates a magnetic force on said movable membrane to cause said lens to move toward or away from said image sensor until said magnetic force is balanced by a spring restoring force on said movable membrane;
whereby the relative distance between said lens and said image sensor can be adjusted accordingly by adjusting said second magnetic field.

8. The method of claim 6 wherein said first magnetic field is predominately perpendicular to said membrane.

9. The method of claim 6 wherein electronic image processing and feedback circuits are connected to said electromagnet to adjust said relative distance between said lens and said image sensor by adjusting said second magnetic field.

10. An auto-focusing system comprising:
an image sensor;
a lens assembly comprising a lens mounted on a movable membrane having a first soft magnetic layer, a second soft magnetic layer, and an electromagnet sandwiched between said first soft magnetic layer and said second soft magnetic layer wherein energizing said electromagnet generates an attractive force between said first soft magnetic layer and said second soft magnetic layer and causes said lens to move toward or away from said image sensor until said attractive force is balanced by a spring restoring force on said movable membrane;
whereby the relative distance between said lens and said image sensor can be adjusted accordingly by adjusting the energizing level of said electromagnet.

11. The auto-focusing system of claim 10 wherein said electromagnet comprises a coil.

12. The auto-focusing system of claim 11 wherein said coil is a planar coil with at least one turn of conductor trace.

13. The auto-focusing system of claim 10 wherein said first magnetic field is predominately perpendicular to said membrane.

14. The auto-focusing system of claim 10 wherein electronic image processing and feedback circuits are connected to said electromagnet to adjust said relative distance between said lens and said image sensor by adjusting said second magnetic field.

15. The auto-focusing system of claim 10 wherein multiples of said lens assembly are stacked together wherein the distance between each individual lens and said image sensor can be adjusted by adjusting the magnetic field produced by the corresponding electromagnet whereby a zooming function can be realized.

16. A method of operating an auto-focusing system comprising the steps of:
providing an image sensor;
providing a lens assembly comprising a lens mounted on a movable membrane having a first soft magnetic layer, a second soft magnetic layer, and an electromagnet sandwiched between said first soft magnetic layer and said second soft magnetic layer;
energizing said electromagnet to generate an attractive force between said first soft magnetic layer and said second soft magnetic layer and to cause said lens to move toward or away from said image sensor until said attractive force is balanced by a spring restoring force on said movable membrane;
whereby the relative distance between said lens and said image sensor can be adjusted accordingly by adjusting the energizing level of said electromagnet.

17. The method of claim 16 wherein said electromagnet comprises a coil.

18. The method of claim 17 wherein said coil is a planar coil with at least one turn of conductor trace.

19. The method of claim 16 wherein said first magnetic field is predominately perpendicular to said membrane.

20. The method of claim 16 wherein electronic image processing and feedback circuits are connected to said electromagnet to adjust said relative distance between said lens and said image sensor by adjusting said second magnetic field.
